(19) United States
(12) Patent Application Publication
(10) Pub. No.: US 2023/0416059 A1
(43) Pub. Date: Dec. 28, 2023

(54) MOBILITY MULE

(71) Applicant: Oshkosh Corporation, Oshkosh, WI (US)

(72) Inventors: Zach Foster, Oshkosh, WI (US); Jeff Parham, Oshkosh, WI (US)

(73) Assignee: Oshkosh Corporation, Oshkosh, WI (US)

(21) Appl. No.: 18/214,154

(22) Filed: Jun. 26, 2023

Related U.S. Application Data
(60) Provisional application No. 63/355,892, filed on Jun. 27, 2022.

(51) Int. Cl. B66C 23/42; B66F 9/065; B66F 9/075; B66C 23/80

(52) U.S. Cl. CPC B66C 23/42; B66F 9/065; B66F 9/07559; B66C 23/80; B66C 23/68

(57) ABSTRACT

A work machine includes a base, a mount coupled to the base, wherein the mount is configured to support an arm. The arm is pivotally coupled to the mount, and includes a boom and an engagement mechanism positioned at the head of the boom. The mount is configured to raise and lower the arm relative the base. The engagement mechanism may include an extendable grabber to interface with one or more objects and lift and position the objects using the mule. The work machine may include a leveling system coupled to the base. The leveling system is configured to stabilize the base in an approximately level position, and includes a plurality of outriggers positionable between a stowed position and a deployed position. A first total width of the work machine in the deployed position is greater than a second total width of the work machine in the stowed position.

### CROSS-REFERENCE TO RELATED PATENT APPLICATIONS

This application claims priority to and the benefit of U.S. Provisional Application No. 63/355,892, filed Jun. 27, 2023, the entire disclosure of which is incorporated by reference herein.

### BACKGROUND

The present disclosure relates generally to mobile work platforms. More specifically, the present disclosure relates to mobile work platforms configured as a mule including an arm for lifting, transporting, and positioning tools and/or construction materials.

### SUMMARY

One embodiment relates to mule including a work machine. The work machine includes a base, a mount, an arm, and a leveling system. The mount is supported by the base. The arm is pivotally coupled to the mount. The arm includes a boom and an engagement mechanism. The boom extends laterally away from an axis of rotation of the arm. The engagement mechanism is positioned at an end of the boom. The leveling system is coupled to the base and configured to stabilize the base in an approximately level position. The leveling system includes a plurality of outriggers positionable between a stowed position and a deployed position. A first total width of the work machine in the deployed position is greater than a second total width of the work machine in the stowed position.

Another embodiment relates to mule including a work machine. The work machine includes a base, a mount, an arm, a first tractive assembly and a second tractive assembly. The mount is supported by the base. The arm is pivotally coupled to the mount. The arm includes a boom and an engagement mechanism. The boom extends laterally away from an axis of rotation of the arm. The engagement mechanism is positioned at an end of the boom. The first tractive assembly is coupled to a first side of the base and the second tractive assembly coupled to a second side of the base. A distance between the first tractive assembly and the second tractive assembly is extendable, such that the work machine is moveable between a transport position wherein the work machine has a first total width and a working position with a second total width, the second total width greater than the first total width.

Another embodiment relates to mule including a work machine. The work machine includes a base, a mount, an arm, a first tractive assembly, a second tractive assembly, and a leveling system. The mount is supported by the base. The arm is pivotally coupled to the mount. The arm includes a boom and an engagement mechanism. The boom extends laterally away from an axis of rotation of the arm. The engagement mechanism is positioned at an end of the boom. The first tractive assembly is coupled to a first side of the base and the second tractive assembly coupled to a second side of the base. A distance between the first tractive assembly and the second tractive assembly is extendable, such that the work machine is moveable between a transport position wherein the work machine has a first total width and a working position with a second total width, the second total width greater than the first total width. The leveling system is coupled to the base and configured to stabilize the base in an approximately level position. The leveling system includes a plurality of outriggers positionable between a stowed position in the transport mode and a deployed position in the working mode.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a mule, according to an exemplary embodiment;

FIG. 2 is a perspective of the mule of FIG. 1, including a leveling system with outriggers in a stowed position, according to an exemplary embodiment;

FIG. 3 is a perspective view of the mule of FIG. 1, including a leveling system with outriggers folded out in a deployed position, according to an exemplary embodiment;

FIG. 4 is a rear view of the mobile work platform of FIG. 1, according to an exemplary embodiment;

FIG. 5 is a left view of a mule for use with a mobile work platform, according to an exemplary embodiment;

FIG. 6 is a block diagram of a controller for the mule of FIG. 1, according to an exemplary embodiment;

FIG. 7 is a perspective view of a mobile work platform with a mule, according to another exemplary embodiment;

FIG. 8 is a rear view of the mobile work platform with a mule of FIG. 5, according to an exemplary embodiment;

FIG. 9 is a perspective view of the mobile work platform of FIG. 5, including tracks retracted in a stowed position, according to an exemplary embodiment;

FIG. 10 is a perspective view of the mobile work platform of FIG. 5, including tracks extended into a deployed position, according to an exemplary embodiment;

FIG. 11 is a perspective view of a mobile work platform with a mule, according to another exemplary embodiment;

FIG. 12 is a rear view of the mobile work platform with a mule of FIG. 9, according to an exemplary embodiment;

FIG. 13 is a perspective view of the mobile work platform of FIG. 9, including a leveling system with outriggers in a stowed position, according to an exemplary embodiment;

FIG. 14 is a perspective view of the mobile work platform of FIG. 9, including a leveling system with outriggers in a deployed position, according to an exemplary embodiment;

FIG. 15 is a left view of a mule for use with a mobile work platform, according to another exemplary embodiment;

FIG. 16 is a left view of a mule for use with a mobile work platform, according to another exemplary embodiment;

FIG. 17 is a perspective view of a mule elevated above a mobile work platform, according to an exemplary embodiment;

FIG. 18 is a perspective view of a mule elevated above a mobile work platform, according to another exemplary embodiment;

FIG. 19 is a perspective view of a mule elevated above a mobile work platform, according to another exemplary embodiment;

FIG. 20 is a perspective view of a mule elevated above a mobile work platform, according to another exemplary embodiment;

FIG. 21 is a perspective view of a lift device to support a mule, according to an exemplary embodiment;

FIG. 22 is a perspective view of a mule mounted to a deck of the lift device of FIG. 20, according to an exemplary embodiment;

FIG. 23 is a front view of the mule mounted to the deck of the lift device of FIG. 20, according to an exemplary embodiment;

FIG. 24 is a left view of the mule mounted to the deck of the lift device of FIG. 20, according to an exemplary embodiment;

FIG. 25 is a left view of a mule mounted to the deck of the lift device of FIG. 20, according to another exemplary embodiment;

FIG. 26 is a perspective view of an adaptor for mounting a mule to the deck of the lift device of FIG. 20, according to an exemplary embodiment;

FIG. 27 is a left view of an adaptor mounted to the deck of the lift device of FIG. 20, according to an exemplary embodiment;

FIG. 28 is a perspective view of a mobile work platform with a mule constructing a masonry wall, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a mobility mule (e.g., a mule) includes a base, a mount configured to support an arm (e.g., a boom, a crane, etc.), wherein the arm is configured to rotate relative to the base and the mount and includes an engagement mechanism (e.g., a hook, a grabber, etc.) to engage with and position one or more objects. The base includes one or more tractive elements allowing the mule to move under its own power. The mount is configured to raise and lower the arm relative to the base as well as rotatably support the arm, such that the arm can rotate relative to the base. In operation a user can control the mule to position itself near a desired object, engage with the object via the engagement mechanism, and lift and/or position the object via the mount and/or the arm 16.

The base can include a leveling system which can be moved between a stowed position and deployed position allowing the mule to maneuver through narrow openings yet maintain a wider, stable base in operation. In some embodiments, the leveling system includes one or more outriggers which contract or fold into the base in the stowed position and extend or fold out into a deployed position away from the base. During construction, it is desirable to repeatedly lift one or more heavy objects (e.g., tools, construction materials, etc.) which may be to heavy or need to be lifted too high to be positioned manually. Such objects may however be too small to justify larger equipment such as cranes, or there may be enough objects that it is inefficient to raise and lower an aerial work platform (e.g., a telehandler, a scissor lift, a boom lift, etc.) multiple times to lift each object. Accordingly, it is desirable to have a system that is small and maneuverable for lifting and positioning objects which reduces the vertical mass which must be raised and lowered, while assisting with lifting.

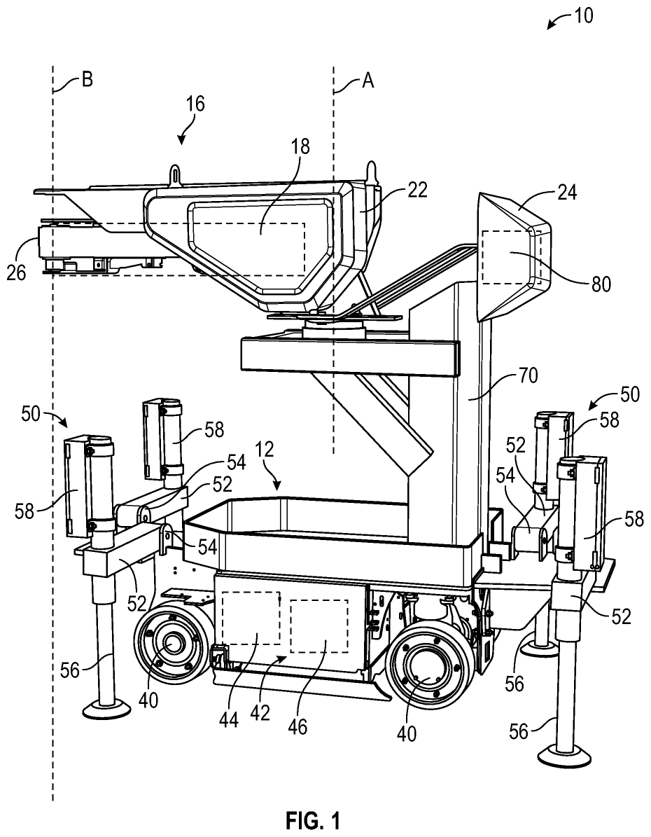

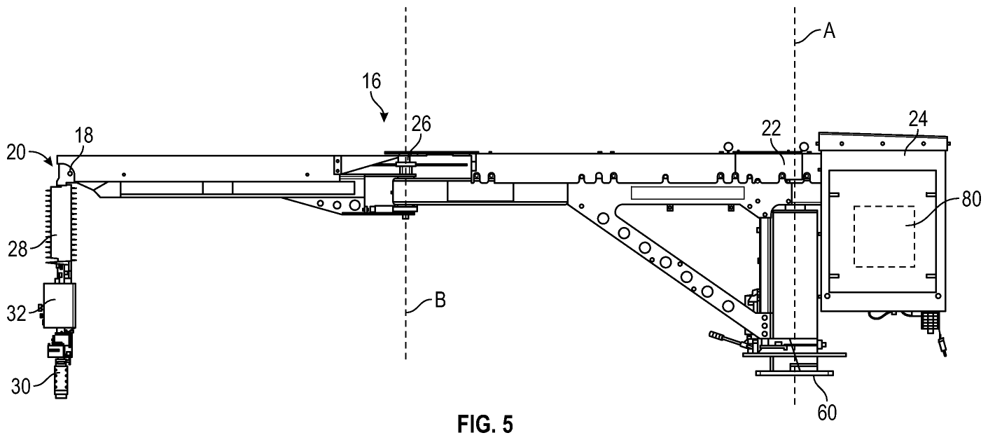

According to the exemplary embodiment shown in FIGS. 1-5, a mobile mule (mobile work platform), shown as mule 10, includes a chassis or base, shown as base 12. A mount (e.g., translatable mount, stationary mount, etc.) shown as mount 70 couples the base 12 to an arm, shown as arm 16. The arm 16 is rotatably supported by the mount 70 which may additionally and/or alternatively be rotatably supported by the base 12.

The mule 10 is supported by a plurality of tractive assemblies 40, each including a tractive element (e.g., a tire, a track, etc.) that are rotatably coupled to the base 12. The tractive assemblies 40 may be powered or unpowered. The tractive assemblies 40 may include a first or front pair of tractive assemblies 40 and a second or rear pair of tractive assemblies 40. The pairs of tractive assemblies 40 may also be a first or left pair of tractive assemblies 40 and a second or right pair of tractive assemblies 40. As shown in FIG. 1, the tractive assemblies 40 are configured to provide powered motion in the direction of a longitudinal axis of the mule 10. One or more of the tractive assemblies 40 may be turnable or steerable to steer the mule 10. In some embodiments, the mule 10 can turn within a five foot radius. In some embodiments, the mule 10 includes a powertrain system 42. In some embodiments, the powertrain system includes a primary driver 44 (e.g., an engine, an electric motor, etc.). A transmission may receive mechanical energy from the primary driver and provide an output to one or more of the tractive assemblies 40. The primary driver 44 may also provide mechanical power for operation of the mount 70 and the arm 16, or for any other function, feature, etc., of the mule 10 that requires power to operate. In some embodiments, the powertrain system 42 includes a pump 46 configured to receive mechanical energy from the primary driver 44 and output a pressurized flow of hydraulic fluid. The pump 46 may supply mechanical energy (e.g., through a pressurized flow of hydraulic fluid) to individual motive drivers (e.g., hydraulic motors) configured to facilitate independently driving each of the tractive assemblies 40. In other embodiments, the powertrain system 42 includes an energy storage device (e.g., a battery, capacitors, ultra-capacitors, etc.) and/or is electrically coupled to an outside source of electrical energy (e.g., a power outlet connected to a power grid). In some such embodiments, one or more of the tractive assemblies 40 include an individual motive driver (e.g., a motor that is electrically coupled to the energy storage device, a hydraulic motor fluidly coupled to the pump 46 etc.) configured to facilitate independently driving one or more of the tractive assemblies 40. The outside source of electrical energy may charge the energy storage device or power the motive drivers directly. The powertrain system 42 may additionally or alternatively provide mechanical energy (e.g., using the pump 46, by supplying electrical energy, etc.) to one or more actuators of the mule 10 (e.g., a leveling actuator, the lift actuator 240, etc.).

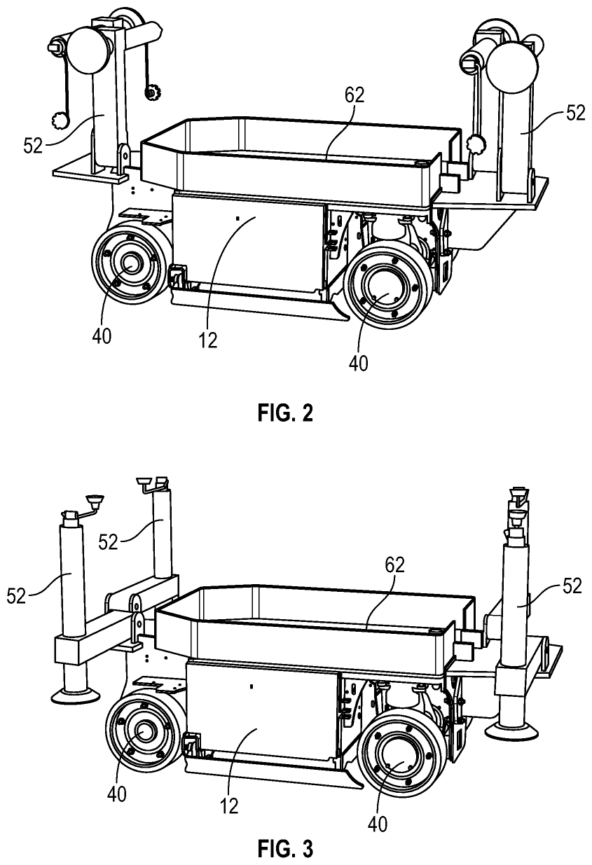

Referring to FIG. 1, the mule 10 includes a leveling system, shown as leveling system 50. The leveling system 50 is configured to provide stability to the mule 10 and level the mule 10 when positioned on uneven ground. The leveling system 50 includes a plurality of outriggers, shown as outriggers 52. Each outriggers 52 is coupled to the base 12 via pivotable connection, shown as outrigger pivots 54. Each of the outriggers 52 include a leg 56 and a leveling mechanism 58. The length of the legs 56 is controlled by the leveling mechanism 58, which is configured to adjust the length of the legs 56 to level the mule 10. The leveling mechanism can be a powered mechanism (e.g., hydraulic actuator, electric actuator, etc.) and/or be powered manually by a user. In some embodiments, a user can extend and retract the legs 56 by turning a crank at a top of each outriggers 52. As shown in FIGS. 2 and 3, the leveling system is configured to stow and deploy the outriggers 52, leveling the mule 10. The leveling system 50 is selectively repositionable between a fully retracted position and a fully extended position. Referring to FIG. 2, the fully retracted position corresponds to a stowed position of the outriggers 52. In the stowed position the legs 56 of the outriggers 52 are retracted by the leveling mechanism 58 to reduce the length of the legs 56 and the outriggers 52 are pivoted about the outrigger pivots 54 such that the legs 56 are substantially parallel with plane of the deck 62. Referring to FIG. 3, the fully extended position corresponds to a deployed position of the leveling system 50. In the deployed position the outriggers 52 pivot about the outrigger pivots 54 until the legs 56 are substantially perpendicular with the deck 62 of the base 12 and/or the ground. In the deployed position the legs 56 are extend and adjusted by the leveling mechanism 58 to level the mule 10. The leveling system 50 can level the mule 10 to up to less than a degree.

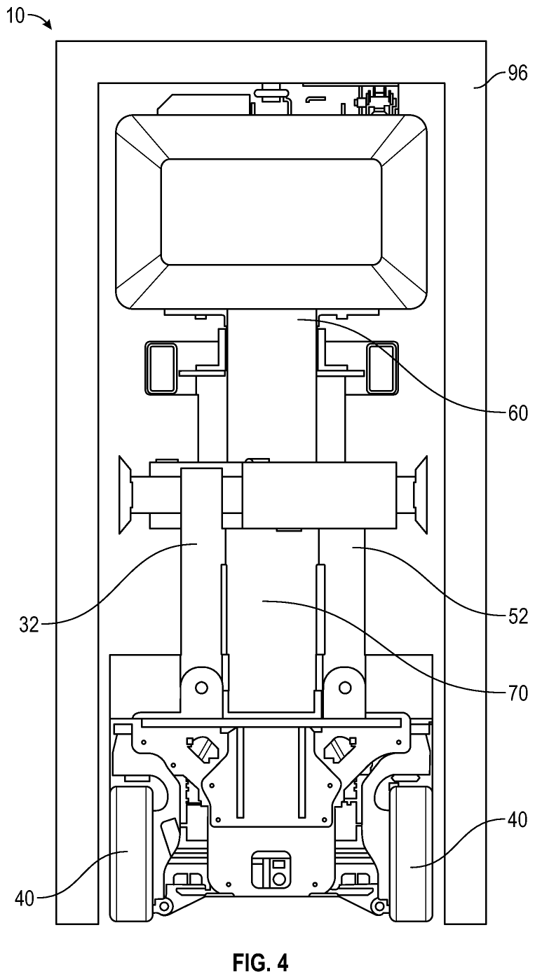

Referring to FIG. 4, in the stowed position the mule 10 is configured to fit within a standard door, shown as door 96. The door can be 34 inches wide. The outriggers 52 can be offset from each other such that when in the stowed positioned the outriggers 52 do not conflict with one another when transitioning between the stowed position and the deployed position. The offset can be due to the position of the outrigger pivots 54 coupling the outriggers 52 to the base 12. Additionally and/or alternatively each outriggers 52 may be angled and/or non-linear.

Referring to FIGS. 1-5, the mule 10 includes a mount, shown as mount 70, which extends upwards from a top surface of the base 12, shown as deck 62. The deck 62 defines a top of the base 12 and is configured to support the mount 70 and/or equipment. The mount 70 is positioned on the deck 62 directly above a first pair of tractive assemblies such as wheels, treads, etc. shown as tractive assemblies 40. Alternatively the mount 70 can be positioned between a first pair of tractive assemblies 40 and a second pair of tractive assemblies 40, or anywhere on the deck 62 of the base 12. The mount 70 is directly coupled to the deck 62 of the base 12. In some embodiments, the mount 70 is configured to extend and retract, raising and lowering the arm 16 relative to the base 12. The mount 70 is selectively repositionable between a fully retracted position and a fully extended position. The fully retracted position corresponds to a fully lowered position of the mule 10. The fully lowered position may be used when the mule 10 is being transported. In some embodiments, the fully lowered position reduces a total height of the mule 10 to less than 79″ such that the mule 10 can fit within a standard door (e.g., 34″×79″). The fully extended position corresponds to a fully raised position of the arm 16. The fully raised position and any positions between the fully raised position and the fully lowered position may be used by an operator when operating the mule 10 (e.g., to transport materials, to perform construction work, etc.). In some embodiments, the fully raised corresponds to a total height of the mule 10 being at least 12.5 feet. Still in other embodiments, the total height of the mule 10 is dependent on the mount 70 and can vary for different applications. The mount 70 may be powered by the powertrain system 42 including the primary driver 44, the pump 46, and/or the energy storage device.

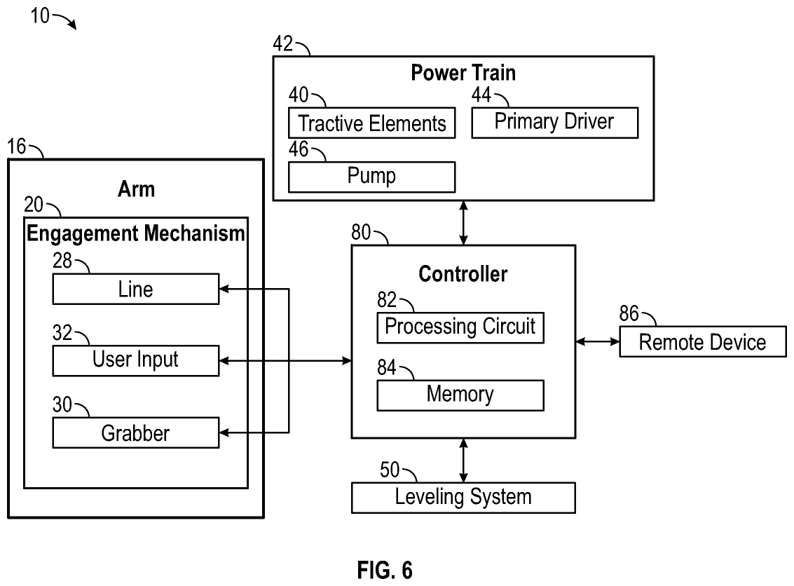

The mount 70 provides a stable, elevated platform for the arm 16. The mount 70 is coupled to the arm 16 at a pivot point, shown as arm pivot 60. Arm pivot 60 can include a gimbal including multiple axes such that the arm 16 is stabilized and can pivot relative to the base 12. The arm 16 can pivot around the mount 70 360° about an axis of rotation, shown as axis A. The arm 16 extends laterally away from the axis A to a first end, shown as head 18 (shown folded behind a portion of the arm 16), and to a second end, shown as a tail 22. The mount 70 can couple to the arm 16 at any point between the head 18 and the tail 22. According to an exemplary embodiment the arm 16 includes a pivot point, shown as elbow 26, around which the head 18 can pivot about a second axis, shown as axis B. The arm 16 is selectively positionable between a fully extended position and a fully retracted position. As shown in FIGS. 1-4 the fully retracted position corresponds to the head 18 of the arm 16 pivoting around the axis B such that the head 18 moves closer to the tail 22. In some embodiments, the head 18 can rotate approximately 180° such that the portion of the arm between the axis B and the head 18 is substantially parallel with the portion of the arm between the axis B and the tail 22 such that the head 18 is essentially folded next to the tail 22. As shown in FIG. 6 the fully extended position corresponds to the arm 16 pivoting around the axis B such that the arm 16 between the head 18 and the tail 22 is substantially straight, and the portion of the arm between the axis B and the head 18 is substantially parallel and collinear with the portion of the arm between the axis B and the tail 22.

According to the exemplary embodiment in FIG. 6, the arm 16 includes a tool (e.g., crane, welder, etc.) shown as engagement mechanism 20, positioned near the head 18 of the arm 16. The engagement mechanism 20 can be powered by the powertrain system 42. In other embodiments, the engagement mechanism 20 is powered by a power source (e.g., battery, generator) on the arm 16. The engagement mechanism 20 includes an extendable load line, shown as line 28, configured to lower and raise an attachment interface (e.g., hook, shackle, grapple, grabber, etc.), shown as a grabber 30. The grabber 30 is configured to raise and lower one or items and/or tools (e.g., masonry blocks, welding implements, beams, etc.). The engagement mechanism is controlled by a user interface (e.g., touch screen, button, switch, etc.) shown as user interface 32. In operation, a user controls the movement of at least one of the base 12, the arm 16, or the engagement mechanism 20 via the user interface 32. For example, in operation a user can command the base 12 to rotate the tractive assemblies 40 and move the mule 10 through a door to a pile of construction materials. The user can then control the leveling system 50 to actuate between a stowed position and a deployed position, including pivoting the outriggers 52 around outrigger pivots 54 to a deployed position and extending the legs 56 to level the mule 10. The user can then control the arm 16 to unfold, such that the head 18 pivots around the elbow 26 until the head 18 and the tail 22 form a substantially straight arm. The user can then command the engagement mechanism to extend the line 28 and lower the grabber 30 such that the grabber 30 can engage with and grasp an item, such as a masonry blocks. The user can then retract the line 28 and raise the grabber 30, and/or rotate the arm 16 around the arm pivot 60 to position the masonry block. The arm 16 may have a carrying capacity of 150 lb. In some embodiments, the arm can carry between 100-200 lbs., including more or less weight so long as the leveling system 50 can maintain a level and stable base 12.

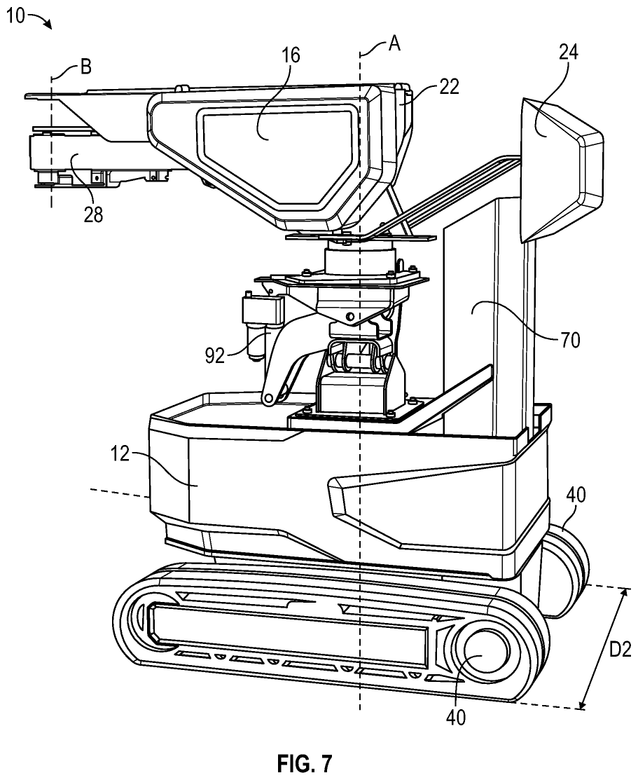

Referring to FIGS. 1-7, the mule 10 may be controlled by a control system, shown as controller 80 positioned in the tail swing cabinet 24. One or more other components (e.g., a generator, a power supply, etc.) can also be stored in the tail swing cabinet 224. The controller may also be positioned elsewhere on the mule 10, for example the controller 80 can be positioned in the base 12. The controller 80 may be communicably coupled to various components of the mule 10 (e.g., base 12, powertrain system 42, mount 70, arm 16, engagement mechanism 20, user interface 32, etc.) such that information or signals (e.g., command signals, hydraulic controls, etc.) may be exchanged from the controller 80. In other embodiments, the controller r80 is coupled to more or fewer components. The information or signals may relate to one or more components of the mule 10. According to an exemplary embodiment, the controller 80 enables an operator (e.g., a user) of the mule 10 to communicate and control one or more components of the mule 10. For example, the controller 80 can receive a user input from the user interface 32 and control the operation of the mule 10 based on the command. The controller 80 may be implemented as a general-purpose processor, an application specific integrated circuit (ASIC), one or more field programmable gate arrays (FPGAs), a digital-signal-processor (DSP), circuits containing one or more processing components, circuitry for supporting a microprocessor, a group of processing components, or other suitable electronic processing components. According to the exemplary embodiment shown in FIG. 7, the controller 80 includes a processing circuit 82 and a memory 84. The processing circuit 82 may include an ASIC, one or more FPGAs, a DSP, circuits containing one or more processing components, circuitry for supporting a microprocessor, a group of processing components, or other suitable electronic processing components. In some embodiments, the processing circuit 82 is configured to execute computer code stored in the memory 84 to facilitate the activities described herein. The memory 84 may be any non-transient volatile or non-volatile computer-readable storage medium capable of storing data or computer code relating to the activities described herein. According to an exemplary embodiment, the memory 84 includes computer code modules (e.g., executable code, object code, source code, script code, machine code, etc.) configured for execution by the processing circuit 82. In some embodiments, controller 80 represents a collection of processing devices (e.g., servers, data centers, etc.), positioned on the mule 10 and/or externally. In such cases, the processing circuit 82 represents the collective processors of the devices, and the memory 84 represents the collective storage devices of the devices.

According to an exemplary embodiment, the controller 80 can communicate with a remote device, shown as remote device 86, and receive commands and information to control the mule 10. The remote device 86 can act the same as user interface 32, and allow a user to wirelessly interact with the mule 10. The controller is shown to communicate with the power train 42 including the tractive elements 42, the primary driver 44, and the pump 46. Similarly the controller 80 is shown to communicate with the arm 16 including the engagement mechanism 20, which itself includes the line 28, the grabber 30, and the user interface 32. The controller 80 can also communicate with the leveling system 50. The controller can control the transition of all or part of the mule 10 from a stowed position to a deployed position. For example, in response to a user command the controller 80 can command the leveling system 50 to lower the outriggers 52 including extending the legs 56 out to contact the ground.

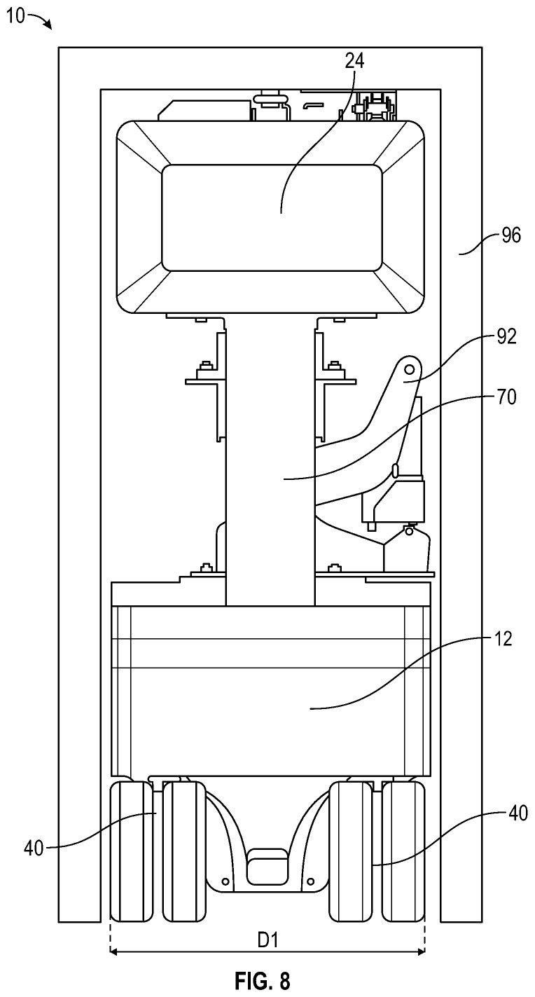

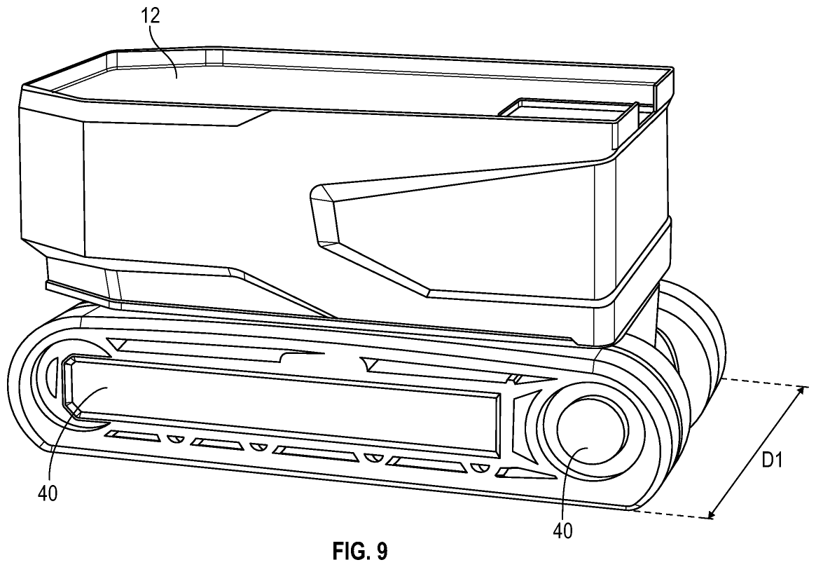

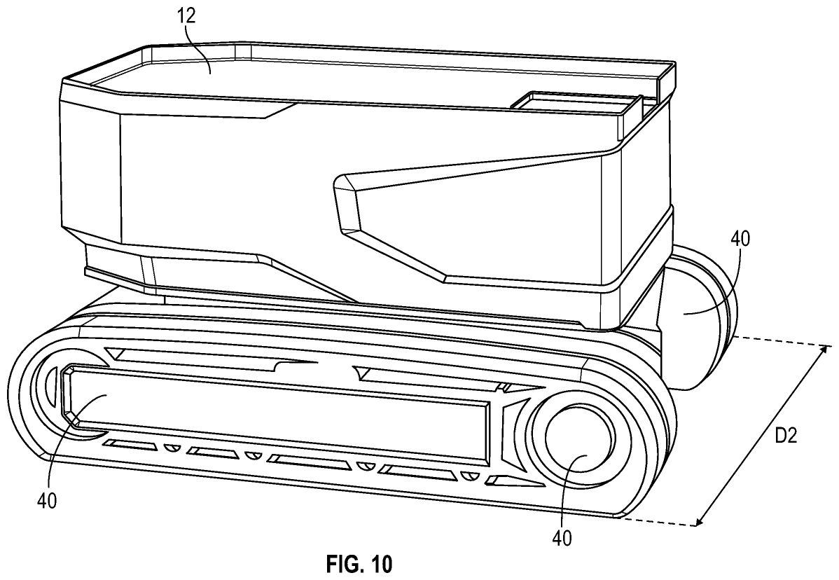

According to the exemplary embodiment shown in FIGS. 7-10, the mule 10 includes a chassis or base, shown as base 12 which supports a mount, shown us gimbal 92, which is rotatably coupled to an arm (e.g., boom, crane, etc.) shown as arm 16. The gimbal 92 may be a one, two, or axes, such that the arm 16 is configured to rotate in a stable position relative to the gimbal 92 and/or the base 12. According to the exemplary embodiment shown in FIGS. 7-10, the leveling system 50 is removed and instead the base 12 is leveled according to the operation of the gimbal 92. The base 12 is supported by one or more tractive assemblies, shown as tracks 90. Each of the tracks 90 can operate independently of the other to steer the mule 10. The tracks 90 can also be tilted or cambered, such that the direction of the mule 10 is altered. The tracks 90 are selectively repositionable between a fully retracted position and a fully extended position. As shown in FIGS. 8 and 9, in the fully retracted position the distance between the tracks is a at a first distance D1. The fully retracted position corresponds to a stowed (e.g., transport) position wherein the tracks are retracted under the base 12 to reduce the distance between the tracks. The retracted position allows the mule 10 to pass through openings, such as door 96, that the mule 10 would otherwise be unable to. As shown in FIGS. 7 and 10, in the fully extended position the distance between the tracks is at a second distance, shown as D2. D2 is larger than D1, as the fully extended position corresponds to a deployed or stable position, wherein the distance between the tracks is increased. The larger D2 provides a wider base for mule 10 to resist rotational forces due to the moment around the gimbal 92 and the arm 16.

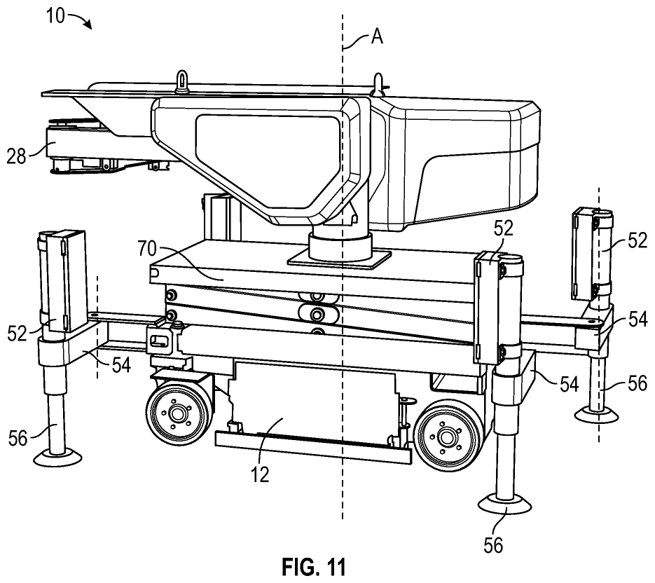

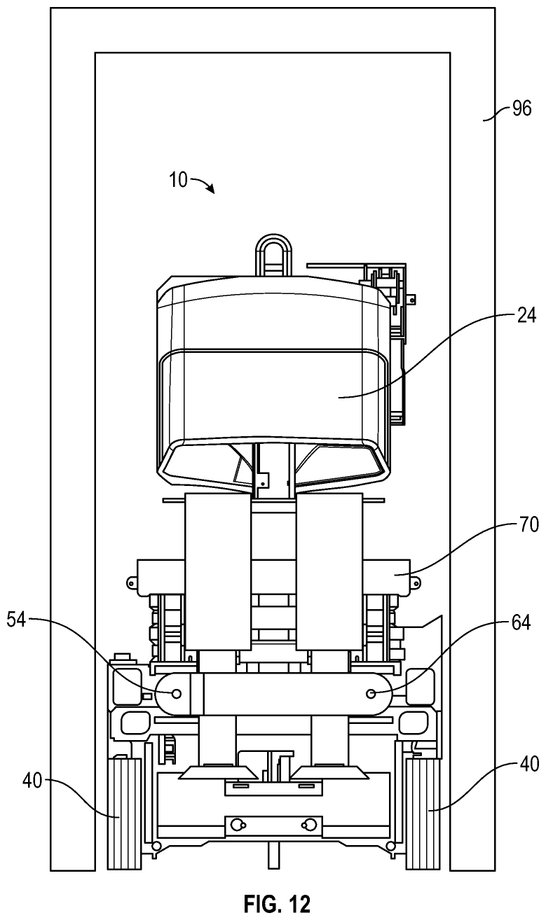

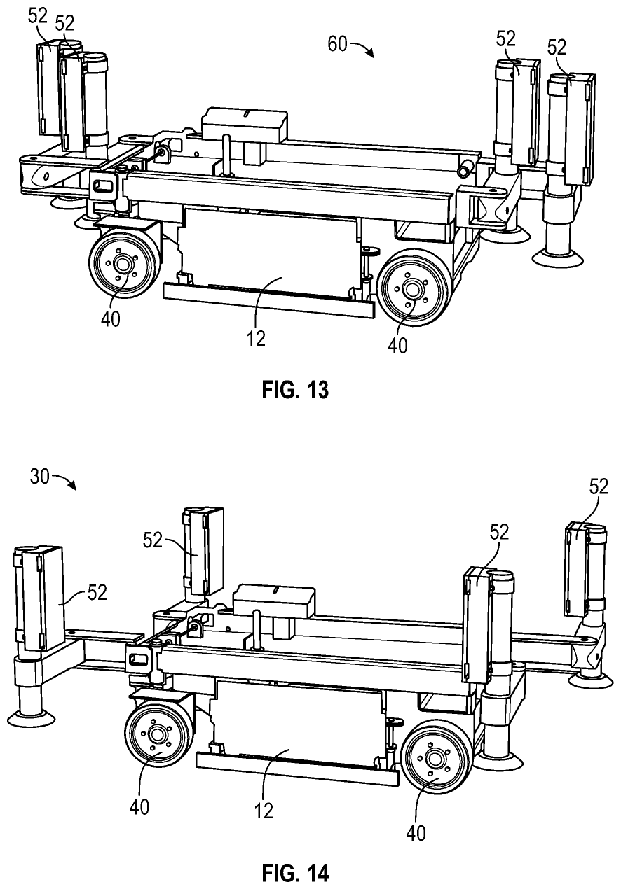

According to the exemplary embodiment shown in FIGS. 11-14, the mule 10 includes a chassis or base, shown as base 12 which supports a mount, shown as mount 70, which is rotatably coupled to an arm (e.g., boom, crane, etc.) shown as arm 16. The arm is coupled to the mount 70 and configured to rotate around a pivot axis, shown as pivot axis A. In some embodiments, the mount 70 is extendable along the A axis such that a vertical distance between the arm 16 and the deck 62 of the base 12 can be extended. In some embodiments, the mount 70 includes a scissor lift mechanism to raise the arm 16. The mule 10 includes a leveling system, shown as leveling system 50 with one or more outriggers, shown as outriggers 52. The outriggers are pivotable relative to the base 12 via outrigger pivots 54. According to the exemplary embodiment shown in FIGS. 11-14, the outrigger pivots 54 rotate around a pivot axis substantially parallel with the pivot axis of the arm 16. The leveling system 50 is configured to stow and deploy the outriggers 52. Specifically, the leveling system 50 is selectively repositionable between a fully retracted position and a fully extended position. Referring to FIGS. 12 and 13, the leveling system 50 is shown in the fully retracted position, which corresponds to the outriggers 52 having rotated around the outrigger pivots 54 such that they are held against the base 12 and do not extend substantially wider (e.g., beyond the outer perimeter) of the base 12. In the stowed position, the mule 10 can pass through doors, such as door 96, that the mule 10 otherwise would not fit through. Referring to FIGS. 11 and 14, the leveling system 50 is shown in the fully extended position, which corresponds to the outriggers 52 extending away from the base 12 by rotating around the outrigger pivots 54 to increase the footprint of the mule 10, such that the legs 56 of the outriggers can be extended to contact the ground and stabilize and/or level the mule 10.

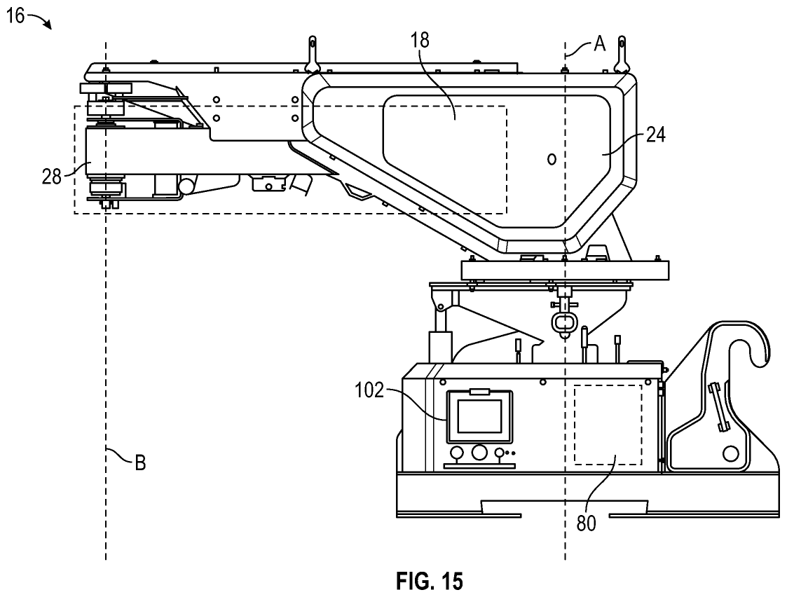

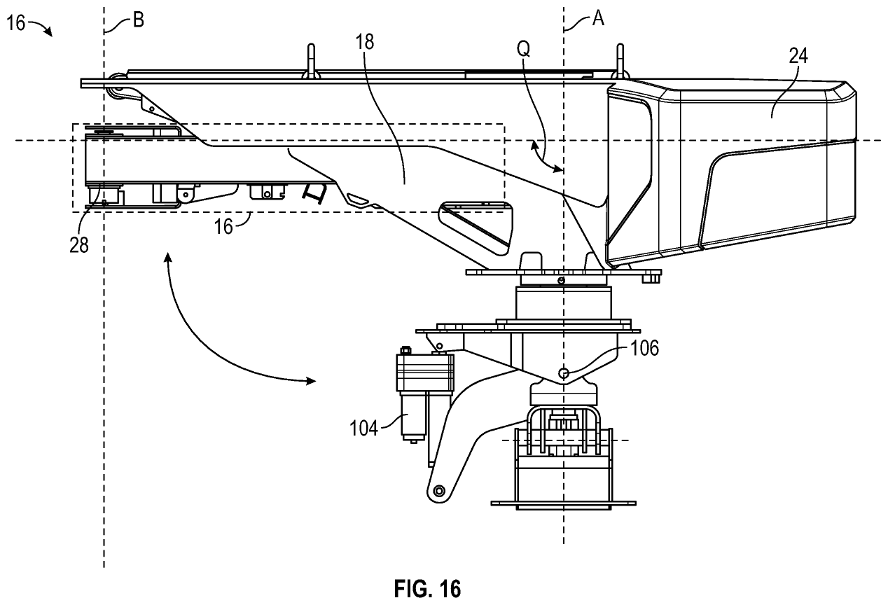

Referring generally to FIGS. 15 and 16, an arm 16 for use with a mule 10 is shown, according to various exemplary embodiments. According to the exemplary embodiment in FIG. 15, the arm 16 includes a lower cabinet, shown as lower cabinet 102, wherein the lower cabinet 102 is configured to replace the tail swing cabinet 24. Instead, one or more components of the arm 16 are positioned below the pivot point 104 in the lower cabinet 102 such that the weight of the rotating mass (e.g., the arm 16) is reduced. The arm 16 is also configured to rotate a full 360° without the lower cabinet 102 acting as interference. Referring still to FIG. 15, the arm 16 is shown in the stowed position. In the stowed position the portion of the arm 16 between the elbow 26 and the head 18 is rotated around the axis B (and as shown in FIG. 15 behind the portion of the arm between the elbow 26 and the tail 22) such that the head 18 is nearer the tail 22, and the total length of the arm 16 is reduced. In the stowed position, the maximum radius of rotation for the arm 16 is therefore smaller than the maximum radius of rotation for the arm 16 in the deployed position.

According to the exemplary embodiment in FIG. 16, the arm 16 includes a tail swing cabinet 24 which is coupled to the tail 22. The tail swing cabinet 24 includes one or more components of the arm 16 (e.g., the controller 80) rotates with the arm 16 about the axis A. The arm 16 includes one or more actuators, shown as actuators 104, which can tilt the arm 16 around pivot point 106. The actuators 104 are selectively actuable such that as the actuator extends, the angle Q between the axis A and a longitudinal axis of the arm 16, shown as axis C, is increased, and as the actuators 104 retract the angle Q is decreased. The arm 16 is also configured to roll around an axis, shown as axis D. When the mule 10 is operated therefore, it rotate (e.g., pan) around three separate axes; specifically, rotate around the axis A, rotate (e.g., tilt) around the axis defined by the pivot point 104, and rotate (e.g., roll) around the axis D. Referring still to FIG. 16, the arm 16 of the mule 10 is shown in the stowed position.

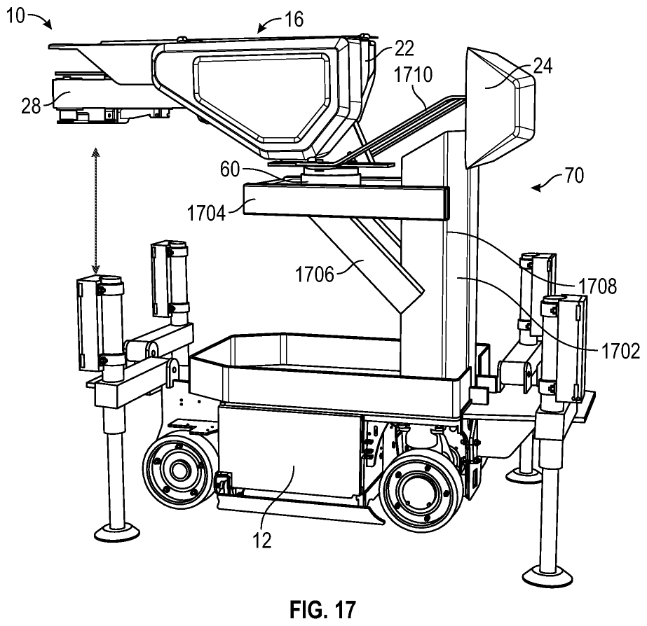

Referring generally to FIGS. 17-20, a mount 70 for rotatably coupling an arm 16 positioned in a stowed position to a base 12 is shown, according to various exemplary embodiments. While some features of mount 70 may not be shown in all embodiments, it should be understood that features illustrated in the various embodiments may be combined with features from the other various embodiments of the mount 70. According to the exemplary embodiment shown in FIG. 17, the mount 70 includes a vertical support structure, shown as mast 1702. The mast 1702 slidably supports a platform 1704 which is coupled to the arm pivot 60. The arm pivot 60 rotatably couples the arm 16 to the mount 70. The platform 1704 is supported by a support member, shown as brace 1706, which is slidably coupled to the mast 1702. In operation, the platform 1704 and the brace 1706 can slide vertically along tracks (e.g., guides, rails, rods, etc.), shown as tracks 1708, to vertically adjust the height of the arm 16 relative to the base 12. In some embodiments, the platform 1704 is powered by the powertrain system 42 and/or another power source to control the height of the platform 1704. In some embodiments, the height is manually adjustable in addition to and/or alternatively to being powered. Still referring to FIG. 17, the tail swing cabinet 24 is shown coupled to the arm 16 via a support bracket, shown as separator 1710. Separator 1710 is shaped such that during rotation of the arm 16 the tail swing cabinet 24 avoids contact with the mast 1702. The arm 16 therefore can rotate a full 360° without interference from the mast 1702.

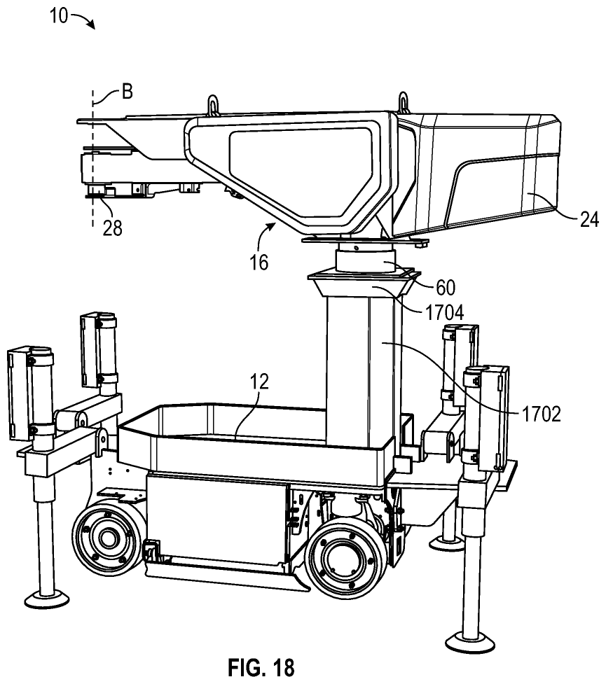

According to the exemplary embodiment in FIG. 18, the arm 16 is shown in the stowed position and the platform 1704 is coupled to a top of the mast 1702 but is not configured to adjust the vertical height of the arm 16. The tail swing cabinet 24 is coupled directly to the tail 22 of the arm 16 and the arm pivot 60 rotatably couples the arm 16 to the platform 1704 such that the lowest point of the arm 16, excluding the engagement mechanism 20 (not shown), thereby allowing the arm 16 to rotate a full 360° without interference from the mast 1702.

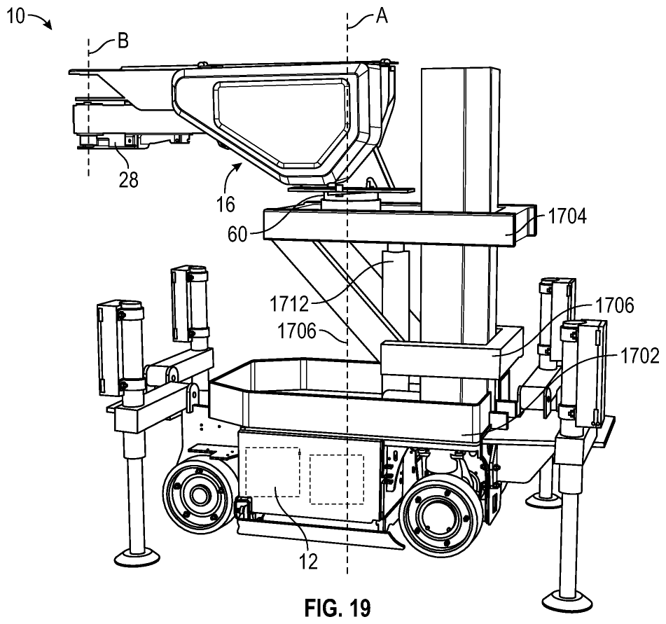

According to the exemplary embodiment in FIG. 19, the mount 70 includes a mast 1702 vertically extending from a deck 62 of the base 12. The mast 1702 slidably supports a platform 1704 which itself supports the arm pivot 60. The arm pivot 60 rotatably supports the arm 16 such that it can rotate around the A axis. The platform is supported by a support member, shown as brace 1706 which is slidably coupled to the mast 1702 via a bracket 1714. Together the platform 1704 and the brace 1706 can be vertically repositioned along the length of the mast 1702 in order to adjust the vertical height of the arm 16 relative to the base 12. The platform 1704 is selectively repositionable via one or more actuators, shown as actuator 1712, coupled on a first end to the mast and on a second end to the platform 1704. As the actuator 1712 extends, the platform 1704 rises vertically away from the base 12 such that the distance between the arm 16 and the base 12 is increased. In some embodiments, the controller 80 (not shown) is configured to limit the rotation of the arm 16 until the platform 1704 is raised to a predetermined height, in order to ensure the arm 16 does not come into contact with the mast 1702. The controller 80 can receive a signal from the actuator 1712 and determine the height of the platform 1704 based on the signal in order to control the rotation of the arm 16.

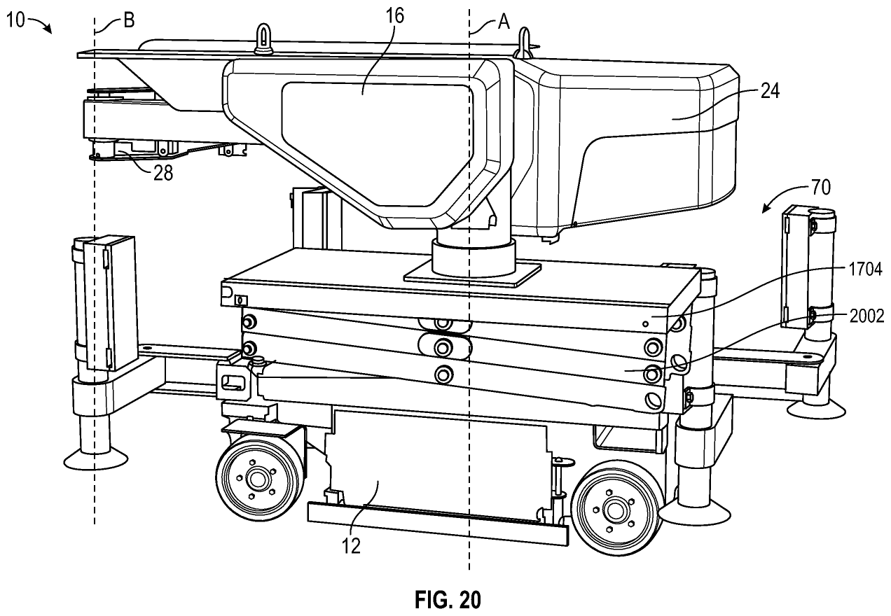

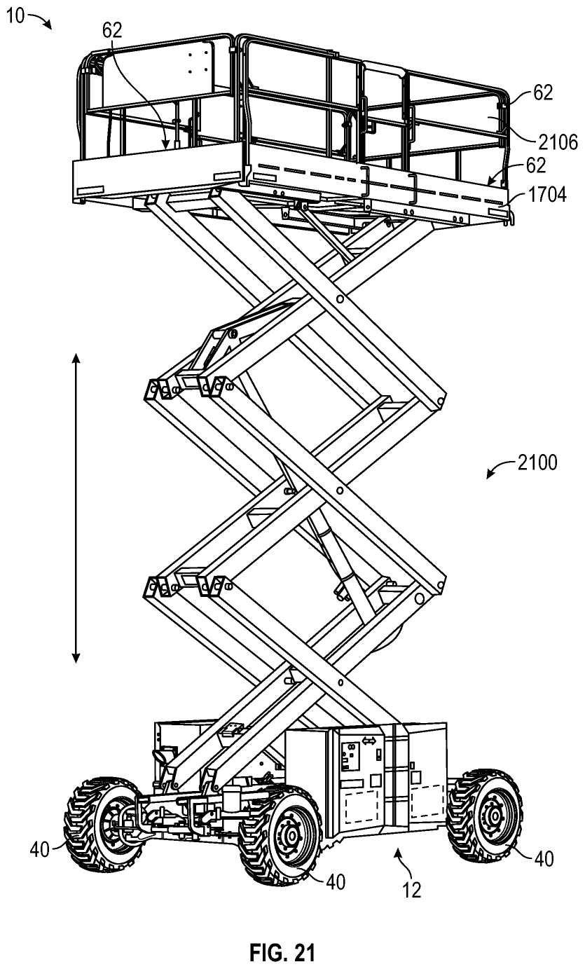

According to the exemplary embodiment in FIG. 20, the mount 70 includes a lift device, shown as scissor lift 2002. The scissor lift 2002 supports a platform 1704 on which the arm pivot 60 is coupled to. The arm pivot 60 rotatably supports the arm 16. In use, the scissor lift 2002 extends and retracts to raise and lower the platform 1704 relative to the base 12 between a fully lowered position and a fully raised position. The scissor lift 2002 is explained in further detail below with reference to FIG. 21.

Referring now to FIG. 21, a lift device, shown as lift device 2100, is positioned between the base 12 and the deck 62 of the mule 10, according to an exemplary embodiment. The deck 62 defines a top surface configured to support operators and/or equipment (e.g., a mount 14, an arm 16, etc.) and a bottom surface opposite the top surface. The bottom surface and/or the top surface extend in a substantially horizontal plane. A thickness of the deck 62 is defined between the top surface and the bottom surface. The bottom surface is coupled to a top end of the lift device 2100. In some embodiments, the deck 62 is rectangular. In some embodiments, the deck 62 has a footprint that is substantially similar to that of the base 12. The mule 10 is configured for outdoor use, and in some embodiments includes one or more tractive assemblies 40 such as wheels and tires that can traverse uneven ground, a tread system, or other tractive assembly.

A series of guards or railings, shown as guard rails 2102, extend upwards from the deck 62. The guard rails 2102 extend around an outer perimeter of the deck 62, partially or fully enclosing a supported area on the top surface of the deck 62 that is configured to support operators and/or equipment. The guard rails 2102 provide a stable support for the operators to hold and facilitate containing the operators and equipment within the supported area. The guard rails 2102 define one or more openings 2106 through which the operators can access the deck 62. The opening 2106 may be a space between two guard rails 2102 along the perimeter of the deck 62, such that the guard rails 2102 do not extend over the opening 2106. Alternatively, the opening 2106 may be defined in a guard rail 64 such that the guard rail 64 extends across the top of the opening 2106. In some embodiments, the platform 1704 includes a door that selectively extends across the opening 2106 to prevent movement through the opening 2106. The door may rotate (e.g., about a vertical axis, about a horizontal axis, etc.) or translate between a closed position and an open position. In the closed position, the door prevents movement through the opening 2106. In the open position, the door does not prevent movement through the opening 2106.

The lift device 2100 is configured to extend and retract, raising and lowering the platform 1704 relative to the base 12. The lift device 2100 is selectively repositionable between a fully retracted position and a fully extended position. The fully retracted position corresponds to a fully lowered position of the platform 1704. The fully lowered position may be used by an operator when entering or exiting the platform 1704 or when transporting the mule 10. The fully extended position corresponds to a fully raised position of the platform 1704. The fully raised position and any positions between the fully raised position and the fully lowered position may be used by the operator when accessing an elevated area (e.g., to operate the arm 16 to perform construction work, to visually inspect an elevated object, etc.).

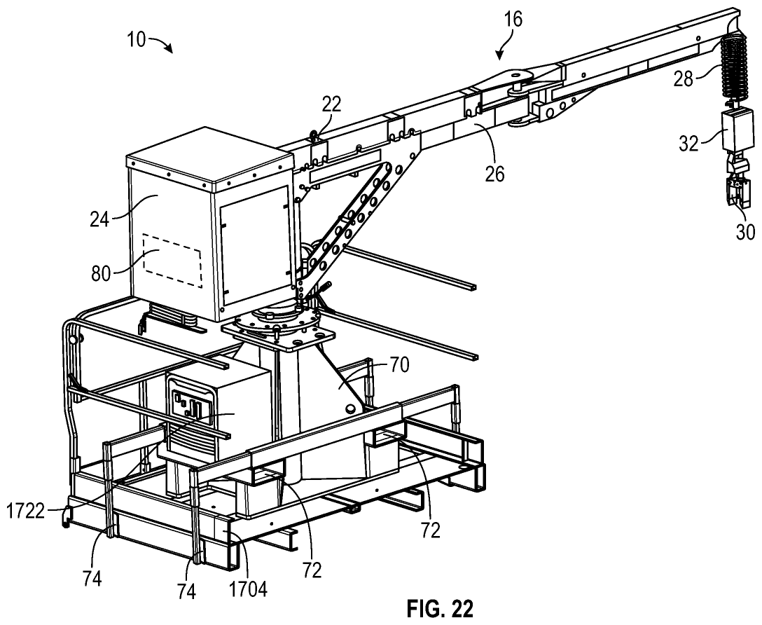

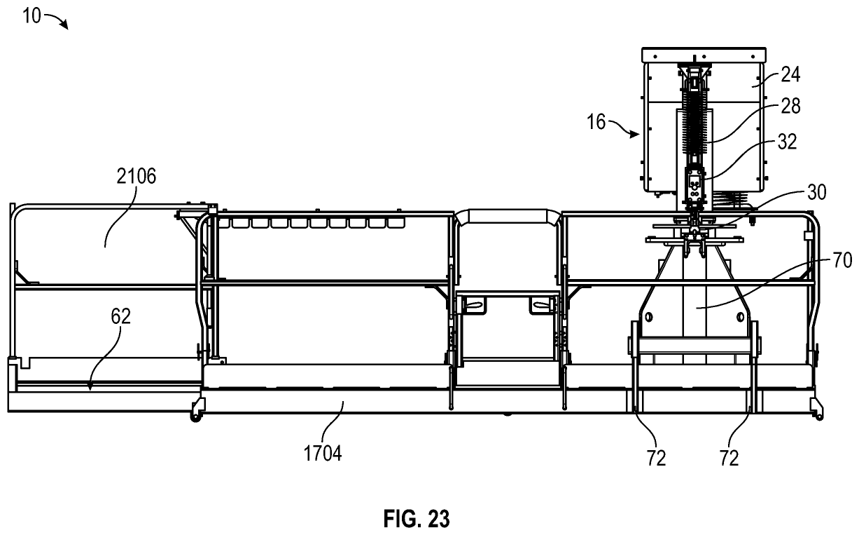

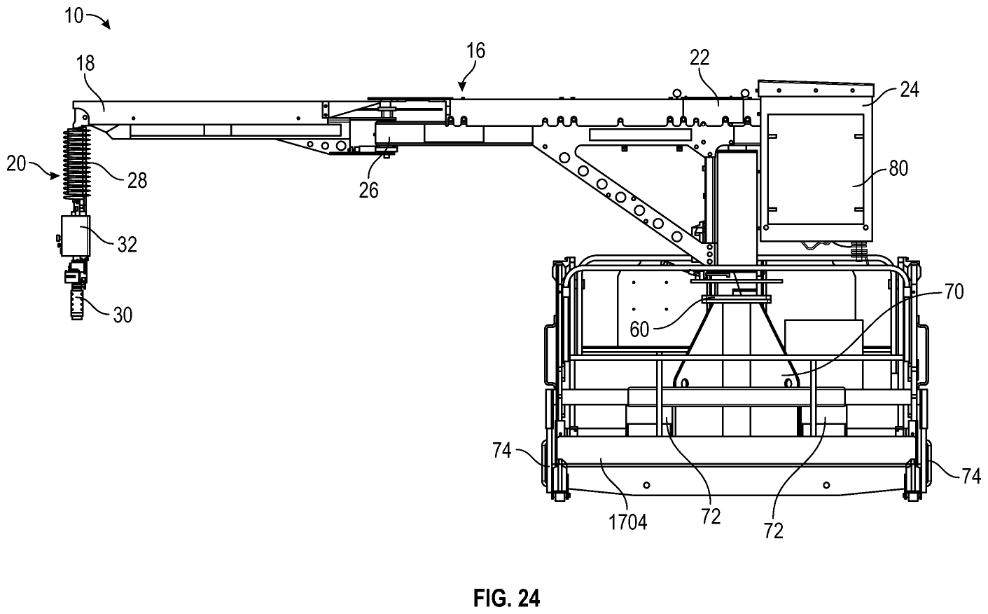

Referring generally to FIGS. 22-28, the mule 10 including the lift device 2100 is shown with the platform 1704 coupled to the top of the lift device 2100 supporting a mount 70 for supporting the arm 16. The mount 70 supports the arm pivot 60. The arm 16 is rotatably coupled to the arm pivot 60 such that the arm 16 can rotate a full 360° relative the platform 1704. The mount 70 and arm 16 may be placed anywhere on the platform 1704. For example, referring to FIGS. 23-24, the mount 70 and arm 16 are shown placed on a side of the platform 1704 opposite an extension deck, shown as extension deck 1720. Referring to FIG. 24, in some embodiments the arm 16 and mount 70 are designed such that the base of the arm pivot 60 is 8 feet above the ground.

In some embodiments, the mount 70 supports a generator, shown as generator 1722, which provides power to the arm 16 when the lift device 2100 is extended and the platform 1704 is elevated above the ground. In some embodiments, the generator is a 3 kw generator. The mount 70 is shown with two fork pockets 72 such for accepting the forks of a fork lift to position the mount 70 and/or the arm 16 onto the platform 1704. The mount 70 also includes one or more clamps 74 to couple the mount 70 onto the platform 1704.

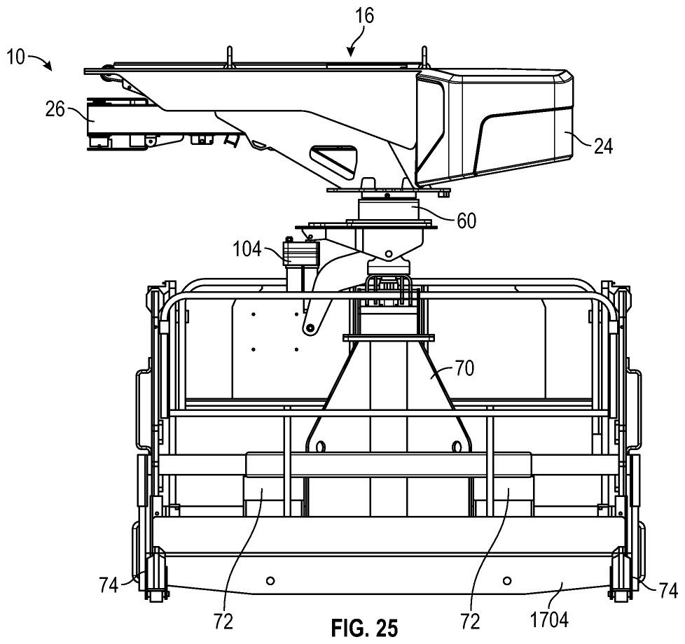

Referring now to FIG. 25, the platform 1704 is shown supporting an arm 16, according to another exemplary embodiment. The arm 16 is shown in a stowed position such that the head 18 of the arm 16 has rotated around the B axis defined by the elbow 26 such that the portion of the arm 16 between the elbow 26 and the head 18 is now parallel (and shown behind) the portion of the arm 16 between the elbow 26 and the tail 22. The tail 22 of the arm 16 is coupled to a tail swing cabinet 24, and the entire arm 16 can rotate relative to the mount 70 and the platform 1704 via the arm pivot 60.

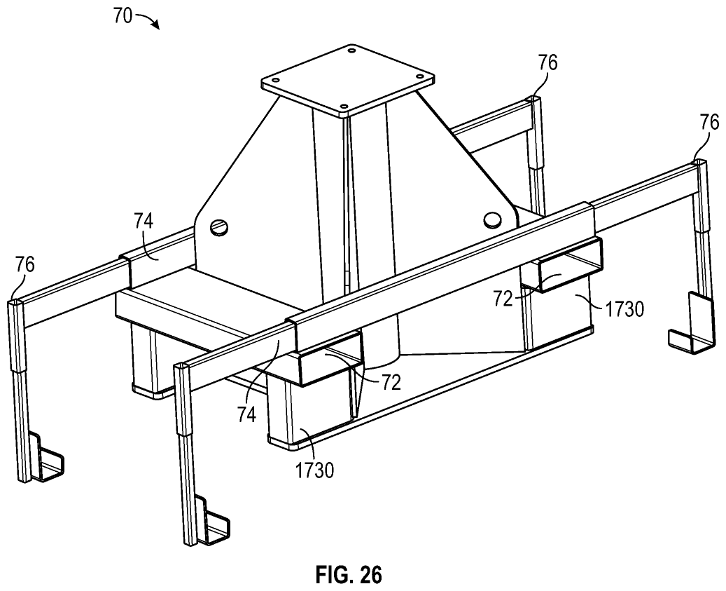

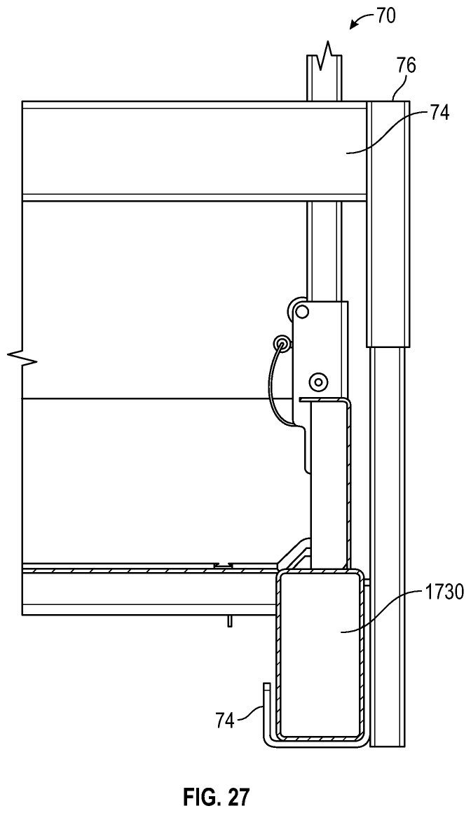

Referring now to FIGS. 26 and 27, the mount 70 includes fork pockets 72 for accepting the forks of a fork lift and one or more clamps, shown as clamps 74. The clamps 74 are configured such that they clasp onto a portion of the platform 1704, shown as extruded tube 1730. The claim 74 can be clamped to the extruded tube 1730 via one or more adjustment mechanisms, shown as adjustment mechanism 76, positioned near a top of each clamps 74. The adjustment mechanism 76 may act as a lock securing the mount 70 to the platform 1704. The clamps 74 may also be adjusted in the horizontal direction via the operation of one or more locking pins 78 that when removed allow the clamps 74 to telescope within itself. The mount 70 also includes a mounting surface, shown as mounting surface 1740.

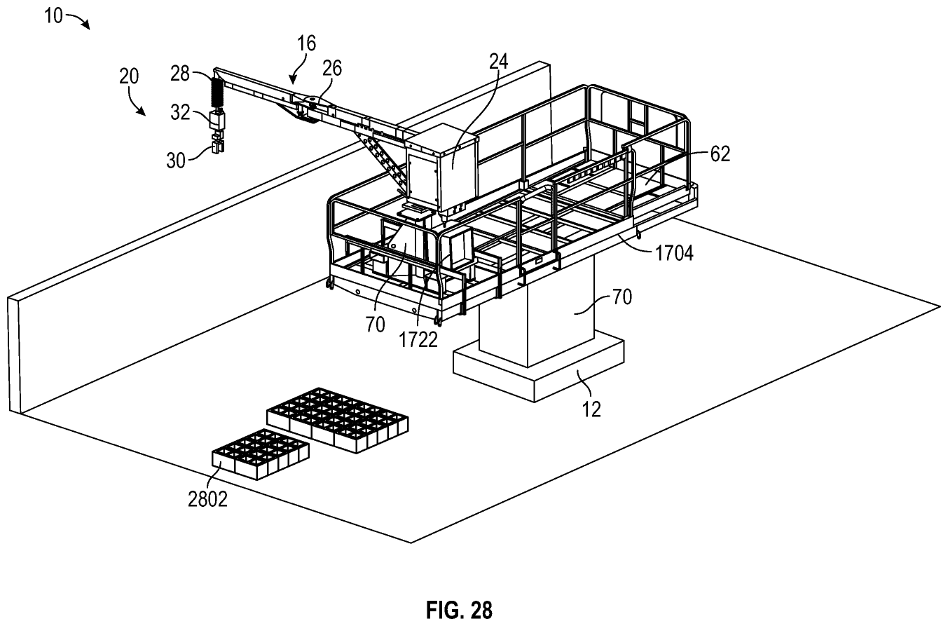

Referring now to FIG. 28, the mule 10 is shown in operation construction a masonry wall out of one or more masonry bricks, shown as bricks 2802. A base 12 supports a lift device (e.g., scissor lift 2002, lift device 2100) shown as lift device 2100 which is configured to raise and lower a platform, shown as platform 1704. Platform 1704 is configured to support an arm 16 via a mount 70. In some embodiments, the arm 16 is mounted in a position offset from a center of the platform 1704. In some embodiments, the arm 16 is mounted on the center of the platform 1704. The mount 70 may be coupled to the platform 1704 without the need for tools. In operation, a fork lift can engage with fork pockets 72 to lift the mount 70 and in some embodiments the arm 16 and set it onto the platform 1704. A user can then position the clamps 74 such that the clamps 74 are positioned above one or more rails of the mount 70, shown as rails 1740. The clamps can be horizontally adjusted by removing one or more locking pins 78 such that the clamps 74 can telescope into themselves and/or out of themselves. The clamps 74 can be adjusted vertically via one or more adjustment mechanisms 76 to engage with a extruded tube of the platform 1704 and couple the mount 70 to the platform 1704.

The mount 70 supports a generator, shown generator 1722, to power the arm 16 and/or rotation of the arm 16. In some embodiments, power is provided via a tether from the base 12 and the powertrain system 42. The mount 70 rotatably supports the arm 16 via an arm pivot 60, such that the arm can rotate a full 360° relative to the platform 1704 and the base 12. The arm 16 includes a head 18 and a tail 22. Coupled to the tail 22 is a tail swing cabinet 24. In some embodiments, the tail swing cabinet 24 includes the controller 80 for operating the mule 10. Near the head 18 of the arm 16 an engagement mechanism 20 is positioned to allow a user of the mule 10 to lift and position one or more objects. In some embodiments, the engagement mechanism 20 includes a line 28, a grabber 30, and a user interface 32. Using the user interface 32 and/or a remote device (not shown) a user can control the grabber 30 to selectively couple to a brick 2802 by lowering the line 28 until the grabber 30 can contact the brick 2802. The user can then raise the line 28 and thereby the grabber 30 and the brick 2802 and rotate, tilt, and/or roll the arm 16 to place the brick 2802 into a desired position, for example on a wall. The mule 10 allows a user to quickly and efficiently lift and position construction materials, especially when the total mass is greater than the carrying capacity of the lift, a user can use the lift to position the bricks 2802 without having to repeatedly raise and lower the entire platform 1704.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the mule 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A work machine comprising
a base;
a mount supported by the base;
an arm pivotally coupled to the mount, the arm comprising:
a boom extending laterally away from an axis of rotation of the arm; and
an engagement mechanism positioned at an end of the boom; and
a leveling system coupled to the base, wherein the leveling system is configured to stabilize the base in an approximately level position, the leveling system comprising a plurality of outriggers positionable between a stowed position and a deployed position, wherein a first total width of the work machine in the deployed position is greater than a second total width of the work machine in the stowed position.

2. The work machine of claim 1, wherein each of the plurality of outriggers comprises:
a lateral member rotatably coupled to the base about a longitudinal axis at a first end;
a leg coupled to a second end of the lateral member, wherein the leg includes a foot vertically translatable relative to the lateral member; and
a leg actuator coupled to the leg to move the leg vertically.

3. The work machine of claim 2, wherein the leg actuator is a hydraulic actuator, an electric actuator, or a manual actuator.

4. The work machine of claim 3, wherein in the stowed position, for each of the plurality of outriggers the leg is retracted by the leg actuator and the lateral member is rotated around the longitudinal axis in a substantially vertical position, and wherein in the deployed position the lateral member is rotated around the longitudinal axis into a substantially horizontal position and the leg is extended by the leg actuator.

5. The work machine of claim 2, wherein the plurality of outriggers comprises a first front outrigger and a second front outrigger, wherein one of the first front outrigger or the second front outrigger is rotatably coupled to the base forward of the other of the first front outrigger or the second front outrigger.

6. The work machine of claim 2, wherein each of the plurality of outriggers are longitudinally offset from each of the other plurality of outriggers.

7. The work machine of claim 1, wherein the mount is extendable vertically away from the base, such that a vertical distance between the boom and the base can be shortened or extended.

8. The work machine of claim 1, wherein the engagement mechanism comprises an extendable grabber.

9. The work machine of claim 1, wherein a stowed distance between the plurality of outriggers and the base in the stowed position is less than 34 inches, and wherein a deployed distance between the plurality of outriggers and the base in the deployed position is greater than 34 inches.

10. The work machine of claim 1, wherein the mount comprises a scissor assembly including a scissor actuator configured to extend and retract the scissor assembly to move the boom between a fully raised and a fully lowered position.

11. The work machine of claim 1, wherein the base further comprises a plurality of tractive elements configured to move the base, wherein the plurality of tractive elements are repositionable between a narrow position with a first width between the plurality of tractive elements and wider position with a second width between the plurality of tractive elements, wherein the second width is greater than the first width.

12. The work machine of claim 11, wherein the plurality of tractive elements comprise a first pair of tractive elements and a second pair of tractive elements, wherein the first pair and the second pair are moveable laterally relative to one another.

13. The work machine of claim 1, wherein the boom further comprises an elbow between a head and a tail of the boom, such that the head is pivotable relative to the tail about a pivot axis parallel with the pivot axis of the boom relative to the base.

14. The work machine of claim 13, wherein the boom pivots about the elbow such that the boom lies on a first side of the axis of rotation.

15. A work machine comprising
a base;
a mount supported by the base;
an arm pivotally coupled to the mount, the arm comprising:
a boom extending laterally away from an axis of rotation of the arm; and
an engagement mechanism positioned at an end of the boom; and
a first tractive assembly coupled to a first side of the base and a second tractive assembly coupled to a second side of the base, wherein a distance between the first tractive assembly and the second tractive assembly is extendable, such that the work machine is moveable between a transport position wherein the work machine has a first total width and a working position with a second total width, the second total width greater than the first total width.

16. The work machine of claim 15, wherein the first tractive assembly and the second tractive assembly comprise a plurality of treads, and wherein distance is perpendicular to a longitudinal axis of the work machine.

17. The work machine of claim 15, further comprising a leveling system coupled to the base, wherein the leveling system is configured to stabilize the base in an approximately level position, the leveling system comprising a plurality of outriggers positionable between a stowed position corresponding with the transport position and a deployed position corresponding with the working position.

18. The work machine of claim 17, wherein each of the plurality of outriggers comprises:
a lateral member rotatably coupled to the base about a longitudinal axis at a first end;
a leg coupled to a second end of the lateral member, wherein the leg includes a foot vertically translatable relative to the lateral member; and
a leg actuator coupled to the leg to move the leg vertically.

19. The work machine of claim 18, wherein in the stowed position, for each of the plurality of outriggers the leg is retracted by the leg actuator and the lateral member is rotated around the longitudinal axis in a substantially vertical position, and wherein in the deployed position the lateral member is rotated around the longitudinal axis into a substantially horizontal position and the leg is extended by the leg actuator.

20. A work machine comprising
a base;
a mount supported by the base;
an arm pivotally coupled to the mount, the arm comprising:
a boom extending laterally away from an axis of rotation of the arm; and
an engagement mechanism positioned at an end of the boom;
a first tractive assembly coupled to a first side of the base and a second tractive assembly coupled to a second side of the base, wherein a distance between the first tractive assembly and the second tractive assembly is extendable, such that the work machine is operable in a transport mode wherein the work machine has a first total width and a working mode with a second total width, the second total width greater than the first total width; and
a leveling system coupled to the base, wherein the leveling system is configured to stabilize the base in an approximately level position, the leveling system comprising a plurality of outriggers positionable between a stowed position in the transport mode and a deployed position in the working mode.
